(19) United States
(12) Patent Application Publication
(10) Pub. No.: US 2026/0364463 A1
(43) Pub. Date: Nov. 19, 2026

(54) INFORMATION PROCESSING DEVICE AND METHOD

(71) Applicant: SONY GROUP CORPORATION, TOKYO (JP)

(72) Inventor: SHOTARO KAMIYA, TOKYO (JP)

(21) Appl. No.: 19/515,808

(22) PCT Filed: Sep. 9, 2024
(86) PCT No.: PCT/JP2024/032145

§ 371 Date: Mar. 3, 2026

(30) Foreign Application Priority Data
Sep. 29, 2023 (JP) 2023-169346

(51) Int. Cl. A63F 13/60; A63F 13/355

(52) U.S. Cl. CPC A63F 13/60; A63F 13/355

(57) ABSTRACT

The present technology relates to an information processing device and method that can improve the quality of user experience. An information processing device includes a media generation unit configured to generate media data for reproducing media including at least one of video and audio of a respective one of a plurality of frames of a test game for evaluating the quality of user experience, the plurality of frames including a frame assigned with meta information for inducing transmission of a controller signal; and a communication unit configured to transmit the media data to a gaming terminal, wherein in a case where the controller signal transmitted by the gaming terminal is received by the communication unit, the media generation unit generates the media data reflecting an operation indicated by the controller signal. The present technology can be applied to a cloud gaming system.

### TECHNICAL FIELD

The present technology relates to an information processing device and method and particularly relates to an information processing device and method that can improve the quality of user experience.

### BACKGROUND ART

Cloud gaming systems that do not require high specifications for the terminal on the user side, in contrast to conventional console game experiences, are attracting attention.

A cloud gaming system is a thin client system in which a main rendering function is placed on the cloud, and a terminal on the user side is in charge of only reception and display of a video and transmission of a controller signal, and thus, a high level of hardware specifications is not required for the terminal on the user side.

On the other hand, since cloud gaming systems are based on communication via a network, evaluation of communication environments is essential for stabilizing the end-to-end (E2E) game experience quality, that is, quality of user experience.

In particular, a cloud gaming system (cloud gaming) is a system in which signals are transmitted in both directions, such as streaming data of video and audio being transmitted in a downlink (down) and a controller signal being transmitted in an uplink (up). That is, the cloud gaming system is an interactive system in which video and audio streaming data is generated based on a controller signal.

Thus, a common method in a video distribution system, such as providing a large buffer on the user terminal side (receiving side) to absorb fluctuations in the quality of the network on the receiving side, is not applicable, and the importance of evaluation of the communication environment is further increasing in order to perform fine control with respect to such quality fluctuations.

There are various factors related to the quality of information transmission between a server that distributes a game and a client that is a user terminal, and there are also various metrics that measure the level of quality or the like.

For example, as a metric, quality of a game screen to be transmitted, an encoding quality factor, a server quality factor, a network quality factor, a terminal quality factor, and the like are known.

From the perspective of the quality of user experience, there is a need for a method of evaluating these metrics in an integrated manner.

As a technology related to game control, a technology for controlling game play for a user based on a default game play style has been proposed (see, for example, PTL 1). Furthermore, as a technology related to quality verification of a game, a technology for detecting the occurrence of a bug during execution of a plurality of automated game application sessions has been proposed (for example, see PTL 2).

### CITATION LIST

### Patent Literature

PTL 1: JP 2021-41227 A
PTL 2: JP 2022-510600 T

### SUMMARY

### Technical Problem

In a cloud-based game provided by a cloud gaming system, a game screen transitions interactively in response to a user's controller input, and the scenes in the game and the controller input change from moment to moment.

Thus, in evaluating the quality of user experience, particularly, the communication environment, in the cloud-based game, it is necessary to consider the user's controller input.

However, since the controller input is not considered in the above-described technology, it cannot be said that the evaluation can be sufficiently performed, and as a result, it is difficult to improve the quality of user experience.

The present technology has been made in view of such circumstances, and an object thereof is to improve the quality of user experience.

### Solution to Problem

An information processing device according to a first aspect of the present technology includes a media generation unit configured to generate media data for reproducing media including at least one of video and audio of a respective one of a plurality of frames of a test game for evaluating quality of user experience, the plurality of frames including a frame assigned with meta information for inducing transmission of a controller signal; and a communication unit configured to transmit the media data to a gaming terminal, wherein in a case where the controller signal transmitted by the gaming terminal is received by the communication unit, the media generation unit generates the media data reflecting an operation indicated by the controller signal.

An information processing method according to the first aspect of the present technology includes: generating media data for reproducing media including at least one of video and audio of a respective one of a plurality of frames of a test game for evaluating quality of user experience, the plurality of frames including a frame assigned with meta information for inducing transmission of a controller signal; transmitting the media data to a gaming terminal; and in a case where the controller signal transmitted by the gaming terminal is received, generating the media data reflecting an operation indicated by the controller signal.

According to a first aspect of the present technology, media data for reproducing media including at least one of video and audio of a respective one of a plurality of frames of a test game for evaluating quality of user experience is generated, the plurality of frames including a frame assigned with meta information for inducing transmission of a controller signal, the media data is transmitted to a gaming terminal, and in a case where the controller signal transmitted by the gaming terminal is received, the media data reflecting an operation indicated by the controller signal is generated.

An information processing device according to a second aspect of the present technology includes: a communication unit configured to receive, from a server, media data for reproducing media including at least one of video and audio of a respective one of a plurality of frames of a test game for evaluating quality of user experience, the plurality of frames including a frame assigned with meta information for inducing transmission of a controller signal; and a quality test processing unit configured to generate evaluation data indicating an evaluation result of the quality of user experience based on an ideal reference that is the media data of the media reproduced in a case where the test game is played in an ideal environment, and the media data received from the server, wherein in a case where the media data of a frame assigned with the meta information is received, the communication unit transmits the controller signal to the server.

An information processing method according to the second aspect of the present technology includes: receiving, from a server, media data for reproducing media including at least one of video and audio of a respective one of a plurality of frames of a test game for evaluating quality of user experience, the plurality of frames including a frame assigned with meta information for inducing transmission of a controller signal; generating evaluation data indicating an evaluation result of the quality of user experience, based on an ideal reference that is the media data of the media reproduced in a case where the test game is played in an ideal environment, and the media data received from the server; and in a case where the media data of a frame assigned with the meta information is received, transmitting the controller signal to the server.

In the second aspect of the present technology, media data for reproducing media including at least one of video and audio of a respective one of a plurality of frames of a test game for evaluating quality of user experience is received from a server, the plurality of frames including a frame assigned with meta information for inducing transmission of a controller signal, evaluation data indicating an evaluation result of the quality of user experience is generated based on an ideal reference that is the media data of the media reproduced in a case where the test game is played in an ideal environment, and the media data received from the server, and in a case where the media data of a frame assigned with the meta information is received, the controller signal is transmitted to the server.

### BRIEF DESCRIPTION OF DRAWINGS

FIG. 1 is a diagram illustrating a configuration example of a cloud gaming system.

FIG. 2 is a diagram for explaining evaluation of the quality of user experience.

FIG. 3 is a diagram for explaining cloud gaming play.

FIG. 4 is a diagram illustrating an example of an ideal reference.

FIG. 5 is a diagram illustrating an example of uplink delay and loss.

FIG. 6 is a diagram illustrating an example of downlink delay and loss.

FIG. 7 is a diagram illustrating a configuration example of a cloud gaming server.

FIG. 8 is a diagram illustrating a configuration example of a test game distribution server.

FIG. 9 is a diagram illustrating a configuration example of a gaming terminal.

FIG. 10 is a flowchart for explaining test game distribution processing.

FIG. 11 is a flowchart for explaining test game execution processing.

FIG. 12 is a flowchart for explaining game distribution processing.

FIG. 13 is a flowchart for explaining game execution processing.

FIG. 14 is a diagram illustrating a configuration example of a computer.

### DESCRIPTION OF EMBODIMENTS

Hereinafter, embodiments to which the present technology is applied will be described with reference to the drawings.

### First Embodiment

### Configuration Example of Cloud Gaming System

The present technology relates to a type of evaluation technology necessary for improving the quality of user experience in a cloud gaming system.

In the present technology, prior to distribution of a cloud-based game, that is, prior to game play via cloud gaming, evaluation is performed regarding quality of user experience determined by a combination of content of the game to be played, the communication environment of the user, and the like.

In particular, the cloud gaming system of the present technology is provided with a test game distribution server that distributes a dedicated test game for performing evaluation related to the quality of user experience.

For example, the quality of user experience is evaluated by transmitting and receiving predetermined data between the test game distribution server and the gaming terminal, which is the terminal on the user side, that is, in an E2E manner, and by aggregating logs of information including jitters in game video and the like.

Evaluation of the reception state of streaming data for each genre or scene of a game given the communication environment of the user can be effective information for individual optimization for each session of game distribution. The present technology provides a detailed evaluation method prior to the individual optimization.

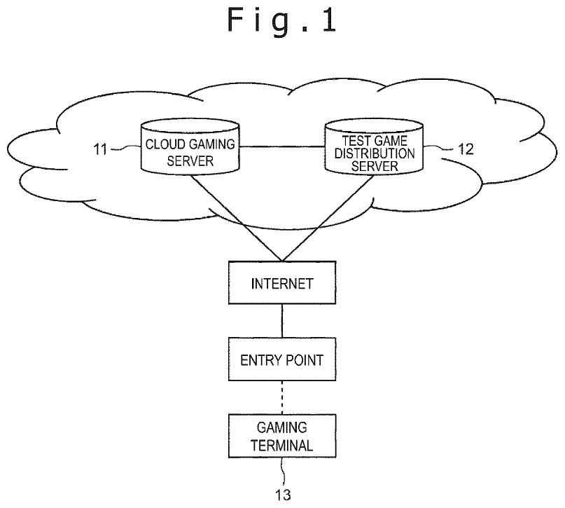

FIG. 1 is a diagram illustrating a configuration example of an embodiment of a cloud gaming system to which the present technology is applied.

The cloud gaming system illustrated in FIG. 1 includes a cloud gaming server 11, a test game distribution server 12, and a gaming terminal 13.

The cloud gaming server 11 is a server that distributes a cloud-based game, that is, distributes a cloud game. The cloud gaming server 11 may be configured by one server (information processing device) or may be configured by a plurality of servers.

The test game distribution server 12 is a server that distributes a test game that is executed prior to the distribution of the game by the cloud gaming server 11. The test game is a dedicated game for evaluating the experience quality of the game provided (distributed) by the cloud gaming server 11.

The test game distribution server 12 may be configured by one server (information processing device) or may be configured by a plurality of servers.

In this example, the cloud gaming server 11 and the test game distribution server 12 are illustrated as different entities. However, no such limitation is intended, and the cloud gaming server 11 and the test game distribution server 12 may be realized by the same device such as one server (information processing device).

The gaming terminal 13 is, for example, an information processing device such as a smartphone, a tablet terminal, a personal computer, a game console, or a head-mounted display owned by the user.

The gaming terminal 13 is connected to a network such as the Internet via an entry point. The entry point is a point for accessing the Internet and is configured by, for example, an access point of a mobile network or a wireless local area network (LAN).

The gaming terminal 13 connects to the cloud gaming server 11 and the test game distribution server 12 via the entry point or the network, receives distribution of a game (cloud game) and a test game, and sends out a controller signal indicating an operation by a user.

Present Technology Evaluation of the quality of user experience and cloud gaming play in a cloud gaming system will be described.

In the cloud gaming system, prior to actual cloud gaming play by a user, a test game for measuring the quality of user experience is executed for each given item such as content (genre) or scenes of the game.

With respect to the test game, data of video and audio reproduced when the test game is played in an ideal environment is shared as an ideal reference between the test game distribution server 12 and the gaming terminal 13 by some means.

In the gaming terminal 13, the evaluation related to the quality of user experience is performed according to the shared ideal reference.

Specifically, a string (data string) of expected reception data, which is streaming data of video and audio received in an ideal environment, is compared with a data string of reception data, which is streaming data of the test game in an actual environment, and the quality of user experience is evaluated.

The evaluation can then be performed on the basis of a suitable error function or the like.

The evaluation result of the quality of user experience may be presented to the user as the degree of comfort of the play on the gaming terminal 13 side, for example.

In addition, for example, evaluation data indicating the evaluation result of the quality of user experience can be supplied to the cloud gaming server 11 via the test game distribution server 12 and shared. By using this evaluation data, the cloud gaming server 11 can perform adaptive streaming control when the game is actually distributed and improve the experience quality when the user actually plays the game.

The test game is not actually displayed on the display screen of the gaming terminal 13, but is executed in the background. That is, the user does not need to actually operate the controller for the test game and does not view the video display of the test game.

If the play time of the test game is too long, the difference between the expected reception data in the ideal environment and the reception data in the actual environment may become too large, and thus the play time of the test game is set to about ten seconds at most (for example, about 600 frames at 60 fps).

Games actually played by users have variations in terms of the genre (content) of the game, scenes in a single game, and the like. Thus, one or more types of test games are executed at a timing when the user does not play, such as a timing when the console (gaming terminal 13) is activated or set to sleep, or a timing when a process other than the play, such as a dark time or a dead time, is executed.

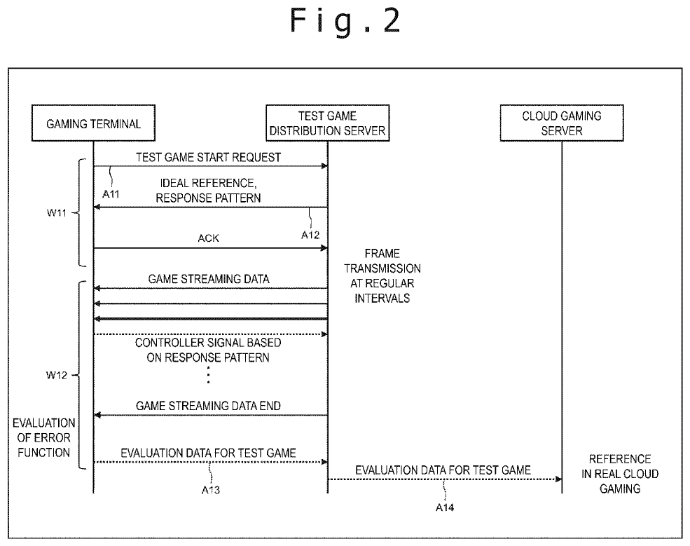

The play of the test game is realized by the exchange of data between the test game distribution server 12 and the gaming terminal 13, as illustrated in FIG. 2, for example.

In FIG. 2, the vertical direction indicates time, and the lower side in the diagram indicates the future side.

In the example of FIG. 2, first, a session of the test game is established in a portion of an initial period W11, and the test game is played (executed) and the quality of user experience is evaluated in a portion of a period W12 following the period W11.

In particular, in the play of the test game, the interaction of the controller input triggered by the reception of a specific video frame of the test game, that is, the transmission of the controller signal is appropriately performed.

For example, in the establishment of a session in the period W11, a test game list, which is list information of a plurality of different test games, is shared.

Note that the test game list may be shared by transmitting the test game list from the test game distribution server 12 to the gaming terminal 13 when a session is established, for example. Alternatively, the gaming terminal 13 may share the test game list by acquiring (receiving) the test game list from the test game distribution server 12 or another device in advance before the period W11.

In the test game distribution server 12, a test game is prepared for each of a plurality of items related to the game, such as each genre (content) of the game provided by the cloud gaming server 11, each scene in the game, and the like. The test game list is a list of a plurality of test games that are prepared in advance and are different from each other, and for example, the test game list includes information such as a test game ID that can uniquely specify each test game.

In the period W11, for example, the gaming terminal 13 selects a game, more specifically, a test game corresponding to an item such as a genre or a scene of the game, from the test game list, according to the genre, scene, or the like of the game intended to be played from now. Here, at least one test game is selected.

As indicated by arrow A11, the gaming terminal 13 transmits a test game start request indicating the selected test game to the test game distribution server 12 and requests the start of the test game. For example, the test game start request includes the selected test game ID.

In the period W11, after the test game start request is transmitted, the ideal reference and the response pattern are shared as indicated by the arrow A12. That is, the ideal reference and the response pattern are transmitted from the test game distribution server 12 to the gaming terminal 13 at an appropriate timing.

The ideal reference is streaming data of the test game that is expected to be received on the gaming terminal 13 side when the test game is played in an ideal environment, and more specifically, data including a data string of media data for reproducing video and audio of the test game.

In particular, the media data of the test game is assumed to include video data for reproducing a video (video frames) of the test game and audio data for reproducing audio (audio frames) of the test game. It is sufficient that the media data of the test data is configured by at least one of video data and audio data.

It is sufficient that the ideal reference includes at least one of video data and audio data as media data. In the following description, it is assumed that the ideal reference includes at least video data as media data.

The response pattern is data indicating a response pattern during the test game, such as a method by which the gaming terminal 13 generates and transmits a controller signal during the test game play, that is, the content (type) and transmission timing of the controller signal to be generated.

In other words, the response pattern is data indicating what operation content of the controller signal is to be transmitted and at what timing when the video frame serving as a trigger for the response is received.

When the gaming terminal 13 receives and records the ideal reference and the response pattern for the test game intended to be played (executed) from now, the gaming terminal 13 appropriately transmits an acknowledgement (ACK) indicating that sharing is complete to the test game distribution server 12.

When a session is established between the gaming terminal 13 and the test game distribution server 12 in the period W11 in this manner, distribution of the test game is then started, and the test game is played (executed) in the period W12.

In the period W12, the test game is distributed from the test game distribution server 12 to the gaming terminal 13 at regular intervals. That is, the frames (media data) of the test game are transmitted to the gaming terminal 13 as streaming data.

In this example, the streaming data of the test game includes at least video data (video frames) of the test game.

In addition, some of the video data (video frames) of the test game is provided with meta information for inducing generation and transmission of a controller signal based on a controller input, that is, a response pattern. Note that the meta information may be added to the audio frame instead of the video frame, but the following description will be made assuming that the meta information is added to the video frame.

The meta information is information indicating a response point (video frame) that triggers generation and transmission of a controller signal.

For example, the meta information is information indicating which of the response points determined in advance is the timing at which the controller input is to be performed, that is, the timing at which the controller signal is to be generated, in the test game. Specifically, for example, the meta information is ID information for identifying the response point or the like.

By referring to the response pattern, the gaming terminal 13 can specify at what timing, such as after how many seconds, and what operation content of the controller signal is to be generated and transmitted with respect to the response point indicated by the meta information.

Specifically, for example, the response pattern is data in which the content of the controller signal (operation content) and the transmission timing of the controller signal, that is, the generation timing, are associated with information (ID information or the like) for specifying the response point.

When the meta information is added to the video data as the streaming data of the test game received from the test game distribution server 12, that is, when the meta information is included in the streaming data (video data), the gaming terminal 13 transmits the controller signal.

That is, the gaming terminal 13 generates a controller signal in accordance with the response pattern and transmits the controller signal to the test game distribution server 12. The generation of the controller signal is performed automatically without requiring a user input operation.

When streaming data of the test game is received, processing such as decoding necessary for reproducing media (game content), that is, video and audio of the test game, can be executed on the basis of the streaming data. However, the display of the video and the output of the audio are not performed.

When the test game distribution server 12 receives the controller signal from the gaming terminal 13, the test game distribution server 12 generates streaming data of video frames and audio frames corresponding to the controller signal and transmits the streaming data to the gaming terminal 13.

The gaming terminal 13 does not generate and transmit a controller signal when the meta information is not added to the video data as the streaming data of the test game received from the test game distribution server 12. Note that in this case also, the processing such as decoding for media reproduction can be executed.

During the period W12, the streaming data of the test game and the controller signal are exchanged (transmitted and received) between the gaming terminal 13 and the test game distribution server 12.

Hereinafter, a video frame assigned with meta information, that is, a frame of the test game serving as a response point, may also be particularly referred to as a trigger frame, and a frame that is not a trigger frame, that is, a frame not assigned with meta information may also be referred to as a non-trigger frame.

In the period W12, when the play (distribution) of the test game is finished, the gaming terminal 13 generates (calculates) evaluation data indicating the evaluation result of the quality of user experience based on the ideal reference (expected reception data) shared in advance and the streaming data (reception data) received during the test game play. For example, the evaluation data is generated by calculation of an appropriate error function determined in advance.

The gaming terminal 13 transmits the generated evaluation data to the test game distribution server 12, as indicated by arrow A13. As indicated by arrow A14, the test game distribution server 12 records the evaluation data received from the gaming terminal 13 and transmits the evaluation data to the cloud gaming server 11 as feedback.

The cloud gaming server 11 uses the evaluation data received from the test game distribution server 12 for actual cloud gaming, that is, streaming control of game distribution.

The evaluation data used for streaming control in the cloud gaming server 11 is data obtained through an evaluation performed in an E2E manner and with consideration of controller input. That is, the evaluation data can be said to indicate a result of integrally evaluating factors (metrics) that affect the quality of user experience while considering interactions including controller input. Thus, by using such evaluation data, it is possible to perform streaming control more appropriately, and it is possible to improve the quality of user experience.

Note that, in executing the test game, the test game may be executed for each genre or scene of the game that the user intends to play or is expected to play. That is, a plurality of different test games may be executed in order in the period W12.

In this case, the quality of user experience is evaluated for each genre or scene, and evaluation data is acquired for each genre or scene. Thus, since it is possible to perform appropriate streaming control for each genre or scene of the game, it is possible to further improve the quality of user experience.

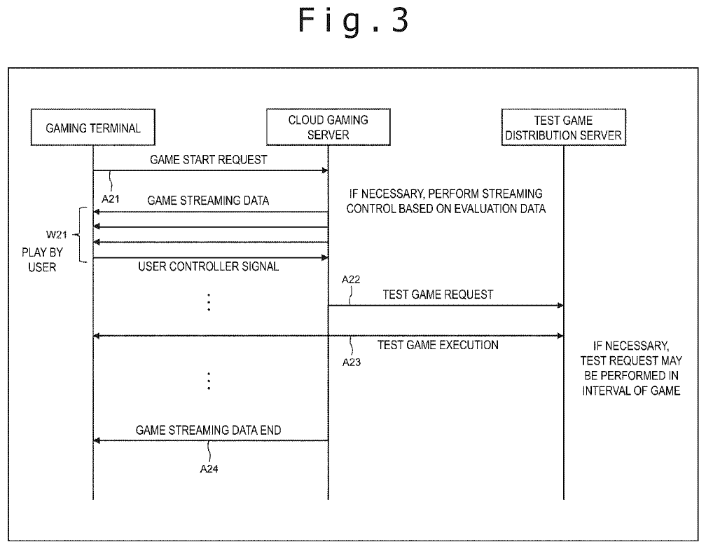

The cloud gaming play will be described with reference to FIG. 3. In FIG. 3, the vertical direction indicates time, and the lower side in the diagram indicates the future side.

In this example, as illustrated by arrow A21, when a game start request is transmitted from the gaming terminal 13 to the cloud gaming server 11, the game is distributed from the cloud gaming server 11 to the gaming terminal 13 in a following period W21.

At this time, the cloud gaming server 11 performs streaming control based on the evaluation data received from the test game distribution server 12 in advance. In addition, in the period W21, when controller input (operation) by the user is performed, the controller signal corresponding to the controller input of the user is transmitted from the gaming terminal 13 to the cloud gaming server 11.

Note that, for example, during the play of the game, at an appropriate timing such as interval time in the game, as indicated by arrow A22, the cloud gaming server 11 may request the test game distribution server 12 to execute the test game.

In this case, the test game distribution server 12 distributes the test game in response to the request from the cloud gaming server 11, as indicated by arrow A23. That is, as described with reference to FIG. 2, the streaming data of the test game and the controller signal are transmitted and received between the test game distribution server 12 and the gaming terminal 13.

When the play of the test game is finished, evaluation data for the executed test game is transmitted from the test game distribution server 12 to the cloud gaming server 11, and the cloud gaming server 11 uses the received evaluation data for subsequent game distribution.

For example, let's assume a case in which the cloud gaming server 11 requests the test game distribution server 12 to execute a test game immediately before a predetermined scene of a game to be distributed to the gaming terminal 13. In such a case, the cloud gaming server 11 can use the evaluation data received in response to the request for execution of the test game for streaming control at the time of distribution of the predetermined scene of the game. In this manner, by using the evaluation data indicating the evaluation result of the quality of user experience performed immediately before the distribution, it is possible to perform more appropriate streaming control.

When the game is distributed from the cloud gaming server 11 to the gaming terminal 13 and the streaming data of the end frame of the game is transmitted as indicated by arrow 24, the game play ends. The end frame is generated when the game is played to the end or when the user issues an instruction to end play during the game, that is, when the user triggers it.

Hereinafter, even if not explicitly described, the end frame of the game is generated when the game is played to the end, when there is a trigger by the user, or the like.

Here, the ideal reference, the response pattern, and the calculation of the evaluation data will be described.

Ideal Reference In the execution of the test game, it is possible to calculate in advance how the video and audio of the test game will change when ideal communication is performed without delay (transmission delay) or loss (frame loss) during transmission of streaming data such as video frames.

In the cloud gaming system of the present technology, the data string of the media data of the test game received on the gaming terminal 13 side in such an ideal communication environment is used as an ideal reference, and the ideal reference is used for calculation of the evaluation data.

The ideal reference may include only a sequence of video frames (images), may include only a sequence of audio frames, or may include a sequence of video frames and audio frames.

For example, when calculating the evaluation data, the reception of the same ideal sequence of video frames and audio frames as the ideal reference is assumed to be 100%, and the difference (error) from the ideal sequence is evaluated by an error function or the like.

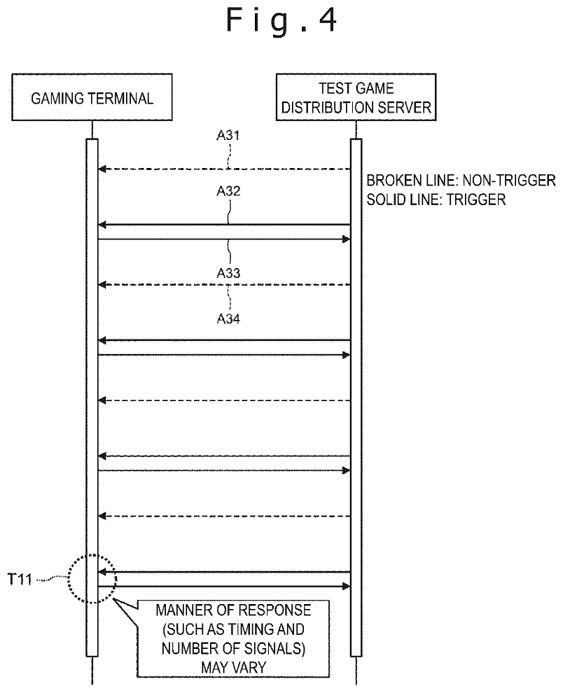

Here, an example of an ideal reference and an example of the occurrence of an error from the ideal reference will be described with reference to FIGS. 4 to 6. In FIGS. 4 to 6, the vertical direction indicates time, and the lower side in the diagram indicates the future side. In FIGS. 4 to 6, the same reference numerals are given to the corresponding portions, and the description thereof will be appropriately omitted.

In an ideal communication environment, for example, as illustrated in FIG. 4, it is assumed that streaming data of a test game, that is, frames of media (video and audio) of the test game, and a controller signal are exchanged.

In this example, the arrows drawn with broken lines (dotted lines) from the test game distribution server 12 side to the gaming terminal 13 side (from left to right in the diagrams), such as arrow A31 and arrow A34, represent the transmission of non-trigger frames. That is, it is indicated that the streaming data of the test game distributed (transmitted) to the gaming terminal 13 is media data for reproducing non-trigger frames.

The arrows drawn with a solid line from the test game distribution server 12 side to the gaming terminal 13 side, such as arrow A32, represent the transmission of trigger frames. That is, it is indicated that the streaming data of the test game distributed (transmitted) to the gaming terminal 13 is media data for reproducing trigger frames.

The media data for reproduction of the trigger frames includes meta information for inducing the generation and transmission of the controller signal described above. That is, meta information is added to the trigger frame.

Thus, when a trigger frame is received on the gaming terminal 13 side, a controller signal corresponding to the meta information added to the trigger frame is generated and transmitted (transferred) to the test game distribution server 12.

In this example, for example, a controller signal indicated by arrow A33 is generated and transmitted in response to a trigger frame indicated by arrow A32. Also, based on the controller signal indicated by the arrow A33, a non-trigger frame indicated by the arrow A34 is generated as the next frame and is transmitted (transferred) to the gaming terminal 13.

In the test game distribution server 12, a sequence of trigger frames and non-trigger frames transmitted at the regular intervals illustrated in FIG. 4, that is, time-series media data, is prepared as the ideal reference.

It is conceivable that the way of responding to the trigger frame at each timing, that is, the timing of the response (generation of the controller signal), the number of controller signals generated as the response, and the like, for example, a portion of a predetermined timing T11, and the like, are different (changed) for each user.

Thus, an ideal reference common to all players (users) may be used regardless of the level of the player or the like, but, for example, a plurality of ideal references having different ways of responding to the trigger frame may be prepared for a single same test game. In this case, for example, it is conceivable to prepare an ideal reference for each level (skill level) of the player, such as a beginner or an advanced player, for one test game.

As with the ideal reference, a response pattern common to all players (users) may be used, or different response patterns may be prepared for different levels (skill levels) of the players. The ideal reference and the response pattern may be prepared for each item related to the user or the game, such as for each type of character operated by the player (user) in the game.

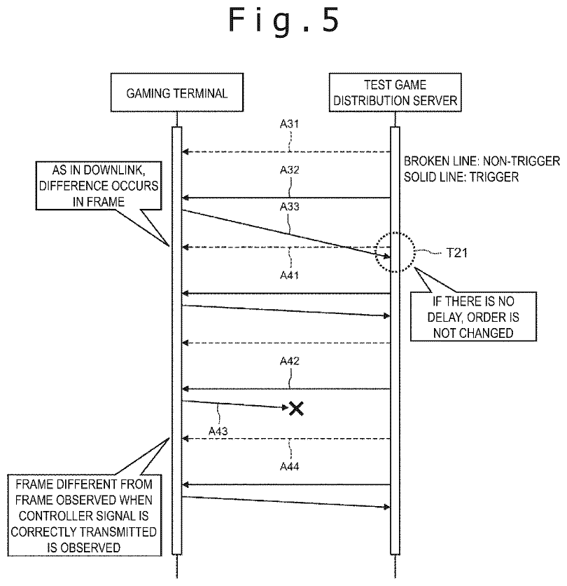

In addition, when a transmission delay or a transmission loss occurs in the uplink, that is, in the transmission from the gaming terminal 13 to the test game distribution server 12, during the play of the test game corresponding to the ideal reference illustrated in FIG. 4, the sequence of the media data on the gaming terminal 13 side is as illustrated in FIG. 5, for example.

In the example illustrated in FIG. 5, for example, a controller signal indicated by the arrow A33 is generated and transmitted (transferred) in response to a trigger frame indicated by the arrow A32, but a delay occurs in the transmission of the controller signal.

Thus, in the portion of timing T21, the order of the timing of reception of the controller signal indicated by the arrow A33 and the timing of transmission of the non-trigger frame indicated by arrow A41 next to the trigger frame indicated by the arrow A32 is reversed. Such a change in the order (before and after) does not occur unless there is a transmission delay.

The non-trigger frame indicated by the arrow A41 is supposed to be generated based on the controller signal indicated by the arrow A33. However, in this example, since a delay occurs in the timing of reception of the controller signal indicated by the arrow A33 due to the transmission delay, the non-trigger frame indicated by the arrow A41 is generated and transmitted assuming that the controller signal is not received.

As a result, a difference occurs in the non-trigger frame indicated by the arrow A41 with respect to the corresponding frame in the ideal reference, and the difference is accumulated as an error when calculating the evaluation data.

Moreover, in this example, the controller signal indicated by the arrow A33, which should have been reflected in the generation of the non-trigger frame indicated by the arrow A41, is reflected in the generation of the next frame, and thus, a further difference from the ideal reference occurs.

In the example illustrated in FIG. 5, a controller signal indicated by arrow A43 is generated and transmitted (transferred) in response to a trigger frame indicated by arrow A42, but the controller signal is lost.

Thus, the non-trigger frame indicated by arrow A44, which should have been generated based on the controller signal indicated by the arrow A43, is generated on the assumption that the controller signal has not been received. Thus, on the gaming terminal 13 side, as the non-trigger frame indicated by the arrow A44, a video frame different from that when the controller signal indicated by the arrow A43 is correctly transmitted is observed (received).

As a result, a difference occurs between the frame received without transmission delay and the corresponding frame in the ideal reference, and the difference is accumulated as an error when calculating the evaluation data.

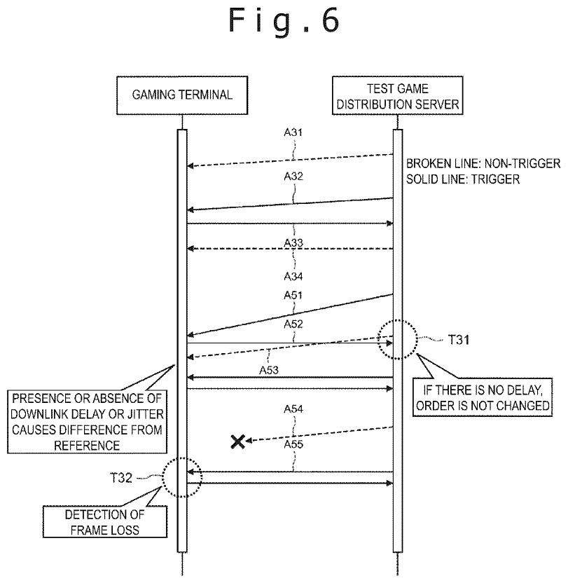

Further, when the test game corresponding to the ideal reference illustrated in FIG. 4 is played, for example, as illustrated in FIG. 6, a transmission delay or a transmission loss (frame loss) may occur in the downlink (down) instead of the uplink (up).

For example, in the example illustrated in FIG. 6, a controller signal indicated by arrow A52 is generated and transmitted (transferred) in response to a trigger frame indicated by arrow A51.

However, since a delay occurs in the transmission of the trigger frame indicated by the arrow A51, the timing of the reception of the controller signal indicated by the arrow A52 on the test game distribution server 12 side is delayed due to the delay.

As a result, in the portion of timing T31, the order of the timing of reception of the controller signal indicated by the arrow A52 and the timing of transmission of the non-trigger frame indicated by arrow A53 next to the trigger frame indicated by the arrow A51 is reversed. That is, the order is changed (before and after) in the same manner as in the case of the timing T21 in FIG. 5.

Thus, a difference occurs in the non-trigger frame indicated by the arrow A53 with respect to the corresponding frame in the ideal reference. In addition, the delay in the reception timing of the non-trigger frame indicated by the arrow A53 causes a shift in the timing of presenting the video frame or the like, or in other words, causes jitters of the video frame or the like.

As a result, a difference between the actually received frame sequence and the ideal reference occurs, and the difference is accumulated as an error when calculating the evaluation data. That is, a difference (error) from the ideal reference occurs due to transmission delay or jitter in the downlink.

In the example of FIG. 6, a non-trigger frame indicated by arrow A54 is lost. Thus, at the subsequent timing T32, the next trigger frame indicated by arrow A55 is received without the non-trigger frame indicated by the arrow A54 being received. In other words, a frame loss occurs.

Such a frame loss also causes a difference to occur between the actually received frame sequence and the ideal reference, and the difference is accumulated as an error when calculating the evaluation data.

### Response Pattern

The response pattern can be said to be prior information for inducing the generation and transmission of a controller signal that causes the gaming terminal 13 side to perform a designated controller input at the timing of the reception of a designated frame, that is, a video frame assigned with meta information. That is, the response pattern is information indicating a pattern of a response when a frame (trigger frame) assigned with meta information is received, and the response pattern is used in generation of a controller signal on the gaming terminal 13 side.

For example, several response patterns are determined in advance for each test game.

As with the ideal reference, a response pattern may be prepared for each level of the player, and which response pattern is used for which ideal reference is determined in advance.

As an example, in a scene where no input from the user (player) is expected, information indicating a response that nothing is input is set as the response pattern.

Further, for example, when the test game is a racing game, information indicating a continuous input that allows the player to appropriately turn in a curved area is set as the response pattern.

### Calculation of Evaluation Data

The ideal reference is a sequence of ideal video frames and audio frames.

Here, for the sake of simplicity, the calculation of the evaluation data will be described by taking, as an example, a case where the ideal reference is a sequence of video frames arranged in time series.

For example, the ideal reference of one test game is expressed as (Xₜ)^{T}ₜ₌₁. Here, t is a parameter indicating a frame, and T is the total number of frames of the video constituting the test game. Further, Xₜ indicates a video (video frame) in a frame t.

The video frame sequence received at the gaming terminal 13 side during the test game play in an actual environment via an exchange with the test game distribution server 12 is expressed as (Yₜ)^{T}ₜ₌₁. Here, Ye is a video (video frame) in the frame t.

In general streaming, a frame number is assigned to each video frame, and thus such a sequence of video frames (Yₜ)^{T}ₜ₌₁ can be acquired.

In the gaming terminal 13, for example, based on the ideal references (Xₜ)^{T}ₜ₌₁ and the received sequence of video frames (Yₜ)^{T}ₜ₌₁, the error, that is, the error function loss, is calculated by calculating the following Equation (1).

$$\begin{matrix}[ Math . 1 ] & \\ loss = {\sum }_{t = 1}^{T} {w}_{t} f ( {X}_{t} , {Y}_{t} ) & ( 1 )\end{matrix}$$

In Equation (1), we is the weighting for the frame t, that is, the weighting determined for each frame. The weighting wₜ may be different for each test game.

In Equation (1), f(Xₜ, Yₜ) is an appropriate function that receives the video frame Xₜ and the video frame Yₜ as inputs and measures an error between the frames. For example, the function f(Xₜ, Yₜ) is a function for acquiring a square error or an absolute error for each bit, a function for acquiring a peak signal to noise ratio (PSNR), a function obtained by combining these functions, or the like.

There are cases where the gaming terminal 13 side cannot receive a video frame due to frame loss.

However, in such a case, in Equation (1), the portion of wtf(Xₜ, Yₜ) of the lost frame t is replaced with a special value predetermined for the frame loss, or is replaced with wtf(Xₜ, Yₜ₋₁) assuming that the same frame as the immediately preceding frame (t−1) is reproduced.

In the gaming terminal 13, evaluation data is calculated based on the error function loss acquired as described above. Note that the value of the error function loss may be used unchanged as the evaluation data.

In this manner, by calculating the evaluation data via the calculation of Equation (1) or the like, it is possible to numerically evaluate the quality of user experience based on the received video frame.

In the streaming control at the time of game distribution by the cloud gaming server 11, basically, evaluation data acquired by execution of a test game is used.

However, no such limitation is intended, and a quality evaluation metric (index) such as jitter related to terminal information or media reproduction or the degree of quality deterioration of received media data may be transmitted (provided) to the cloud gaming server 11 together with the evaluation data, or the evaluation data may be calculated also using the quality evaluation metric.

The terminal information is information related to the gaming terminal 13. Specifically, the terminal information includes, for example, position information indicating the position of the gaming terminal 13, speed information indicating the moving speed of the gaming terminal 13, information indicating the congested state of communication (communication state) of 5G, Wi-Fi (registered trademark), and the like. The information indicating the communication state is information indicating, for example, the signal strength at the gaming terminal 13, the state of delay in the network performing communication, and the like.

The jitter related to media reproduction is a deviation (variation) in the reception timing of video frames and audio frames and can be calculated from the video frames and audio frames of the test game received by the gaming terminal 13, that is, the reception timing of the frames, and the like. Further, the quality deterioration of the media data is, for example, image quality deterioration of a received video frame. In the present technology, since the ideal reference is prepared in advance, it is possible to evaluate the image quality deterioration of the video frame via, for example, PSNR evaluation of the image quality based on the ideal reference and the received video frame.

As a method of sharing the ideal reference and the response pattern from the test game distribution server 12 to the gaming terminal 13 in advance, a method of distributing the ideal reference and the response pattern on demand (default), a method of sharing all the ideal references and the response patterns in a batch, and the like are conceivable.

In addition, for example, a cache may be provided in the gaming terminal 13, and some ideal references and response patterns, such as ideal references and response patterns of test games that are frequently executed, may be held in the cache according to the play history of the test games. That is, the ideal references and the response patterns that have a high use frequency may be held in the gaming terminal 13.

### Configuration Example of Cloud Gaming Server

Configuration examples of the cloud gaming server 11, the test game distribution server 12, and the gaming terminal 13 constituting the cloud gaming system illustrated in FIG. 1 will now be described.

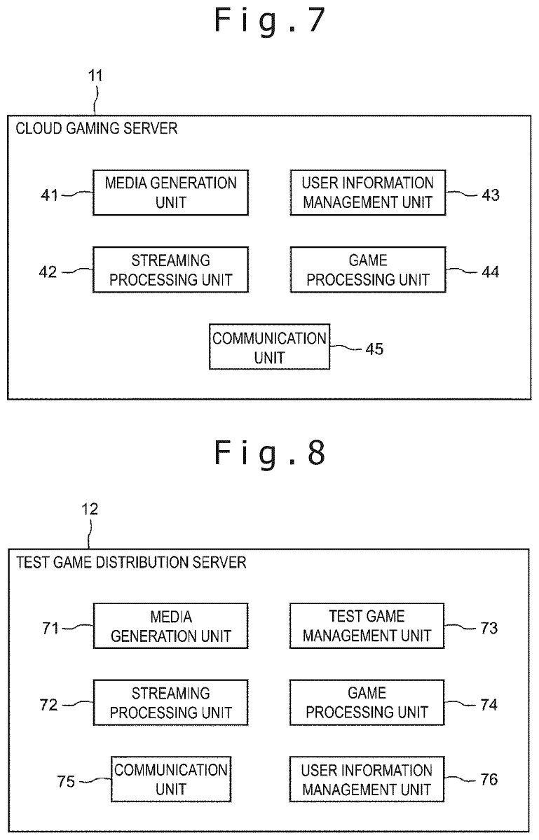

FIG. 7 is a diagram illustrating an example of a functional configuration of the cloud gaming server 11.

The cloud gaming server 11 includes a media generation unit 41, a streaming processing unit 42, a user information management unit 43, a game processing unit 44, and a communication unit 45.

When a controller signal is received from the gaming terminal 13, the media generation unit 41 generates video data (video frames) and audio data (audio frames) as game media data in accordance with the controller signal.

The streaming processing unit 42 executes necessary processing such as encoding on the generated media data of the game to form the media data into streaming data of a format that can be transmitted to the gaming terminal 13.

In the streaming processing unit 42, adaptive streaming control based on the evaluation data of the quality of user experience is performed at the time of forming the streaming data, that is, at the time of generating the streaming data.

In other words, the streaming processing unit 42 performs streaming control during streaming distribution of streaming data (media data) of the game to the gaming terminal 13, based on the evaluation data.

Specifically, for example, as the streaming control, a change (control) of communication redundancy such as forward error correction (FEC), a setting (control) of a transmission rate (bit rate) of a video frame or the like, that is, streaming image quality (image quality of a video frame), and the like are dynamically (adaptively) performed. In particular, the communication redundancy and the bit rate of the video frame are intelligently controlled (selected) based on the evaluation data that is the evaluation result for each environment in which the user plays the game, which is acquired by the test game.

The user information management unit 43 includes, for example, a non-volatile memory and manages evaluation data of the quality of user experience acquired by the test game.

For example, the user information management unit 43 manages a user ID for uniquely identifying a user and evaluation data acquired for the user indicated by the user ID in association with each other. The function (mechanism) of managing the evaluation data of the user, which is realized by the user information management unit 43, may be provided in the test game distribution server 12.

The game processing unit 44 executes processing such as decoding as appropriate on the controller signal received from the gaming terminal 13 and supplies the controller signal to the media generation unit 41.

The communication unit 45 communicates with the gaming terminal 13 and the test game distribution server 12. For example, the communication unit 45 receives a controller signal transmitted by the gaming terminal 13 and transmits streaming data of the game to the gaming terminal 13.

### Configuration Example of Test Game Distribution Server

FIG. 8 is a diagram illustrating an example of a functional configuration of the test game distribution server 12.

The test game distribution server 12 includes a media generation unit 71, a streaming processing unit 72, a test game management unit 73, a game processing unit 74, a communication unit 75, and a user information management unit 76.

When a controller signal is received from the gaming terminal 13, the media generation unit 71 generates video data (video frames) and audio data (audio frames) as media data of the test game in accordance with the controller signal.

The streaming processing unit 72 executes necessary processing such as encoding on the generated media data of the test game to form the media data into streaming data of a format that can be transmitted to the gaming terminal 13.

The test game management unit 73 includes, for example, a non-volatile memory and manages a plurality of test patterns, that is, test games generated for each item related to the game such as a genre or a scene.

For example, the test game management unit 73 loads data related to an appropriate test game in response to a request from the gaming terminal 13, supplies the data to the media generation unit 71 and the game processing unit 74 as appropriate, and instructs the generation of media data of the test game and the like.

The test game management unit 73 also manages (holds) and shares ideal references and response patterns corresponding to the test game.

The game processing unit 74 executes processing such as decoding as appropriate on the controller signal received from the gaming terminal 13 and supplies the controller signal to the media generation unit 71.

The communication unit 75 communicates with the gaming terminal 13 and the cloud gaming server 11. For example, the communication unit 75 transmits the ideal reference and the response pattern to the gaming terminal 13, receives the evaluation data from the gaming terminal 13, and transmits the evaluation data to the cloud gaming server 11.

The user information management unit 76 includes, for example, a non-volatile memory, holds the evaluation data received from the gaming terminal 13 for each test game, transmits the held evaluation data via the communication unit 75, and shares the evaluation data with the cloud gaming server 11.

The cloud gaming server 11 may also function as the test game distribution server 12.

In such a case, for example, the media generation unit 41, the streaming processing unit 42, the game processing unit 44, and the communication unit 45 of the cloud gaming server 11 also function as the media generation unit 71, the streaming processing unit 72, the game processing unit 74, and the communication unit 75 of the test game distribution server 12.

### Configuration Example of Gaming Terminal

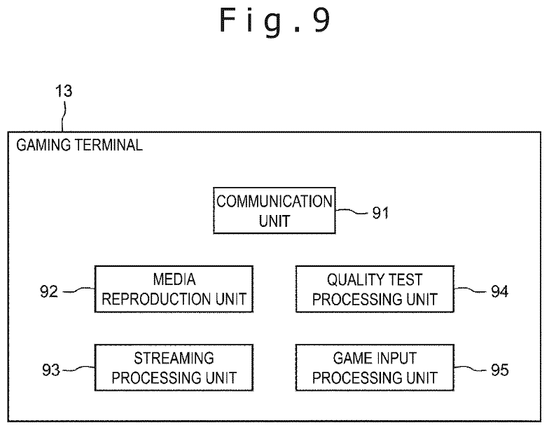

FIG. 9 is a diagram illustrating an example of the functional configuration of the gaming terminal 13.

The gaming terminal 13 includes a communication unit 91, a media reproduction unit 92, a streaming processing unit 93, a quality test processing unit 94, and a game input processing unit 95.

The communication unit 91 communicates with the test game distribution server 12 and the cloud gaming server 11. The media reproduction unit 92 includes, for example, a display, a speaker, and the like and reproduces game media, that is, video (video frames) and audio (audio frames) based on the game media data.

The streaming processing unit 93 executes necessary processing such as decoding on the received streaming data of the test game or the game to convert the streaming data into media data of a format that enables reproduction of the media.

The quality test processing unit 94 realizes a function related to the test game.

For example, the quality test processing unit 94 realizes a function of requesting the test game distribution server 12 to distribute (transmit) a test game, that is, a function of transmitting a test game start request. In addition, for example, the quality test processing unit 94 also realizes a function of receiving (acquiring) and holding an ideal reference and a response pattern as prior information necessary for playing the test game.

For example, the quality test processing unit 94 also realizes a function of comparing the media data of the test game that is in a state of being reproducible by the media reproduction unit 92 and the ideal reference, a function of calculating the evaluation data by calculating an error function or the like, and a function of forming the evaluation data into a transmittable format.

The game input processing unit 95 generates a controller signal in accordance with an input operation (controller input) from the user or an operation designated by the quality test processing unit 94 and forms the controller signal into a data format that can be transmitted to an external device by processing such as encoding.

Description of Test Game Distribution Processing Processing executed in the cloud gaming system illustrated in FIG. 1 will now be described.

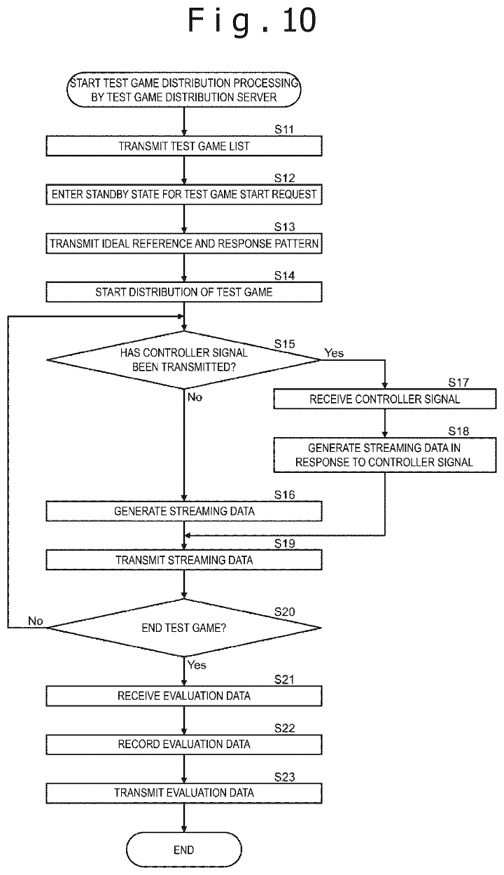

First, the test game distribution processing executed by the test game distribution server 12 will be described with reference to the flowchart of FIG. 10. This test game distribution processing is executed, for example, at the timing when the test game distribution server 12 is activated.

After the test game distribution processing is started, when the communication unit 75 receives a transmission request for the test game list transmitted from the gaming terminal 13 at an arbitrary timing, the test game management unit 73 reads the test game list from the memory (not illustrated) and supplies the test game list to the communication unit 75.

In step S11, the communication unit 75 transmits the test game list supplied from the test game management unit 73 to the gaming terminal 13. Note that the test game list may be shared (transmitted) at any timing.

In step S12, the test game management unit 73 controls the communication unit 75 to establish a session with the gaming terminal 13 and enters a standby state for a test game start request.

In the gaming terminal 13, a test game is selected from the test game list at any timing. Then, a test game start request indicating the selected test game is transmitted from the gaming terminal 13 to the test game distribution server 12, and the communication unit 75 receives the transmitted test game start request and supplies it to the test game management unit 73. For example, the test game start request includes the user ID and the test game ID of the test game requested to be executed.

The test game management unit 73 reads the ideal reference and the response pattern of the test game specified by the test game start request from the memory (not illustrated) and supplies the ideal reference and the response pattern to the communication unit 75.

In this case, when an ideal reference and a response pattern are prepared for each level of the player in the test game, the test game management unit 73 reads the ideal reference and the response pattern prepared for the level of the user of the gaming terminal 13 and supplies the ideal reference and the response pattern to the communication unit 75.

For example, the information indicating the level of the user (player) may be included in the test game start request.

Further, for example, information indicating the level of the user and the user ID may be managed in association with each other by the user information management unit 76, and the user ID may be included in the test game start request. In such a case, the test game management unit 73 acquires information indicating the level of the user associated with the user ID from the user information management unit 76 based on the user ID included in the test game start request.

In addition, the level of the user as a player may be determined from the play record (history) of the game of the user in the user information management unit 76 or the gaming terminal 13.

In step S13, the communication unit 75 transmits the ideal reference and the response pattern supplied from the test game management unit 73 to the gaming terminal 13.

In this manner, the ideal reference and the response pattern are shared. The ideal reference and the response pattern may be transmitted at a timing immediately before the execution of the test game for each test game, or the ideal reference and the response pattern of a plurality of test games may be transmitted as a batch at the same timing. The ideal reference and the response pattern may be shared in advance before the session is established.

The test game distribution server 12 can more appropriately evaluate the quality of user experience by preparing a test game, an ideal reference, and a response pattern for each subdivided item, such as preparing a test game for each genre or scene of a game, or preparing an ideal reference and a response pattern for each level of a player.

When the ideal reference and the response pattern are shared and the communication unit 75 receives an acknowledgement (ACK) or the like indicating that the sharing is completed from the gaming terminal 13, the processing of step S14 is executed.

In step S14, the test game management unit 73 starts the distribution of the test game.

Specifically, the test game management unit 73 loads data related to the test game from a memory (not illustrated), supplies the data to the media generation unit 71 and the game processing unit 74, and instructs the media generation unit 71 and the game processing unit 74 to generate media data and the like.

The media generation unit 71 generates video data and audio data of each frame of the test game as media data of the test game based on the data supplied from the test game management unit 73 in response to an instruction from the test game management unit 73.

In generating the media data, the media generation unit 71 adds the meta information to the video frame of the trigger frame in response to an instruction from the test game management unit 73.

The streaming processing unit 72 executes necessary processing such as encoding on the media data of the test game generated by the media generation unit 71 and supplies the streaming data acquired as a result of the processing to the communication unit 75. The communication unit 75 transmits the streaming data of the test game supplied from the streaming processing unit 72 to the gaming terminal 13.

Thus, prior to the play of the game on the gaming terminal 13, streaming distribution of the test game corresponding to the game, and more specifically, corresponding to the genre and scene of the game, is started.

When streaming distribution of the test game, that is, transmission (distribution) of the streaming data (media data) of the test game is started, the media generation unit 71 generates media data of frames of the test game at regular intervals. The media data of each of the plurality of frames for reproducing the media (video and audio) of the test game includes media data of a trigger frame assigned with meta information and media data of a non-trigger frame not assigned with meta information.

When the distribution (play) of the test game is started, then a controller signal is transmitted from the gaming terminal 13 as a response to the trigger frame as appropriate.

In step S15, the communication unit 75 determines whether or not a controller signal has been transmitted.

In step S15, if it is determined that no controller signal has been transmitted, in step S16, the media generation unit 71 determines that there is no controller signal and generates streaming data of a frame to be transmitted in the test game.

More specifically, the media generation unit 71 generates media data assuming that there is no controller signal, and the streaming processing unit 72 performs forming on the media data generated by the media generation unit 71 and supplies the acquired streaming data to the communication unit 75.

On the other hand, in step 515, when it is determined that a controller signal has been transmitted, in step 517, the communication unit 75 receives the controller signal transmitted from the gaming terminal 13 and supplies the controller signal to the game processing unit 74.

The game processing unit 74 executes processing such as decoding as appropriate on the controller signal supplied from the communication unit 75 and supplies the controller signal to the media generation unit 71.

In step S18, the media generation unit 71 generates streaming data in accordance with the controller signal supplied from the game processing unit 74.

Specifically, the media generation unit 71 dynamically generates media data reflecting an input operation indicated by the controller signal based on the controller signal. The streaming processing unit 72 also performs forming on the media data generated by the media generation unit 71 and supplies the acquired streaming data to the communication unit 75.

In this manner, when the controller signal transmitted by the gaming terminal 13 is received during streaming distribution of the test game, media data reflecting the operation content indicated by the controller signal is generated.

In step S18 and step S16, the meta information is added to the video data (video frames) generated as the media data for the trigger frame, and the meta information is not added to the non-trigger frame. In addition, for the non-trigger frame, meta information indicating that the non-trigger frame is not a response point may be added to the video data.

After the processing of step S16 or step S18 is executed, the processing of step S19 is executed.

In step S19, the communication unit 75 transmits the streaming data of the test game supplied from the streaming processing unit 72 to the gaming terminal 13.

In step S20, the test game management unit 73 determines whether or not to end the test game.

For example, when the media data of the last frame of the test game, that is, the end frame, is generated by the media generation unit 71 and the streaming data corresponding to the media data is transmitted, the test game management unit 73 determines to end the test game.

In step S20, when it is determined that the test game has not yet ended, the processing returns to step S15, and the above-described processing is repeated.

On the other hand, in step 520, when it is determined to end the test game, the processing proceeds to step 521.

When the test game is finished, the evaluation data of the quality of user experience acquired via play of the test game is transmitted from the gaming terminal 13 to the test game distribution server 12.

In step 521, the communication unit 75 receives the evaluation data transmitted from the gaming terminal 13 and supplies the evaluation data to the user information management unit 76.

In step S22, the user information management unit 76 supplies the evaluation data supplied from the communication unit 75 to a memory (not illustrated) and records the evaluation data in association with the user ID and the test game ID.

The user information management unit 76 also supplies the evaluation data acquired via execution (play) of the test game and the user ID to the communication unit 75 and instructs the communication unit 75 to transmit the evaluation data and the user ID to the cloud gaming server 11.

In step S23, the communication unit 75 transmits the evaluation data and the user ID supplied from the user information management unit 76 to the cloud gaming server 11, and the test game distribution processing is ended.

In the cloud gaming server 11, the evaluation data and the user ID transmitted from the test game distribution server 12 are received by the communication unit 45. The user information management unit 43 also records the evaluation data and the user ID received by the communication unit 45 in a memory (not illustrated) in association with each other. In this case, the evaluation data is recorded so that it is possible to specify which genre or scene of the game the evaluation data corresponds to. That is, for example, information indicating a genre or a scene of the game, the evaluation data, and the user ID are recorded in association with each other.

Note that information related to quality evaluation (quality evaluation metric) such as user terminal information, jitter related to media reproduction, and the degree of quality deterioration of media data may be transmitted from the gaming terminal 13 to the test game distribution server 12 along with the evaluation data.

In such a case, in step S21, information related to quality evaluation (quality evaluation metric) such as the terminal information is received together with the evaluation data, and in step S22, not only the evaluation data but also the received information related to quality evaluation is recorded.

Further, in step S23, in addition to the evaluation data and the user ID, information related to the quality evaluation (quality evaluation metric) such as the terminal information is also transmitted to the cloud gaming server 11.

In addition, after the session with the gaming terminal 13 is established, only one test game may be executed, or a plurality of test games may be executed.

For example, in a case where a plurality of different test games such as test games corresponding to a plurality of scenes or a plurality of genres are collectively performed in one session, the processing from step S14 to step S22 described above is executed for each test game.

As described above, the test game distribution server 12 executes a test game taking controller input into account, receives evaluation data acquired as a result of the test game, and records the evaluation data and/or transmits the evaluation data to the cloud gaming server 11.

By executing such a test game, it is possible to acquire evaluation data obtained in an E2E manner and taking controller input into account, and thus it is possible to improve the quality of user experience during actual game play.

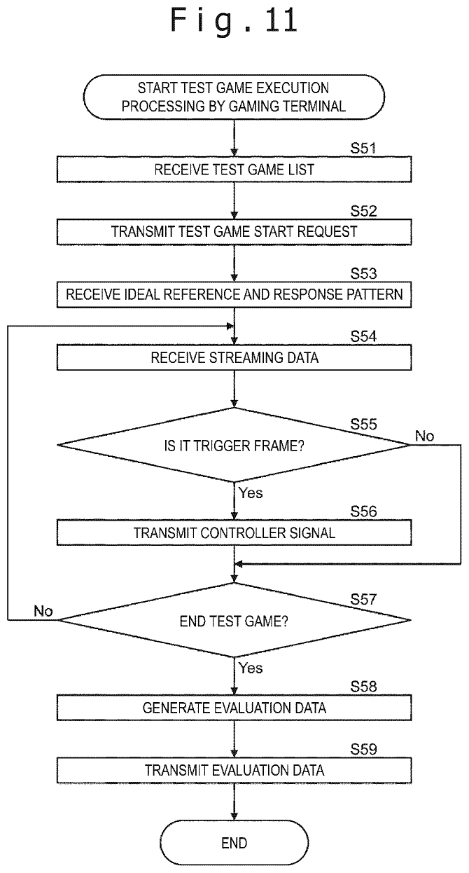

Description of Test Game Execution Processing When the processing of step S11 is executed in the test game distribution processing described with reference to FIG. 10, the test game execution processing illustrated in FIG. 11 is started in the gaming terminal 13.

Hereinafter, the test game execution processing executed by the gaming terminal 13 will be described with reference to the flowchart of FIG. 11.

In step S51, the communication unit 91 receives the test game list transmitted from the test game distribution server 12 in step S11 of FIG. 10 and supplies the test game list to the quality test processing unit 94. The quality test processing unit 94 supplies the test game list supplied from the communication unit 91 to a memory (not illustrated) to be recorded.

The quality test processing unit 94 selects a test game to request to be executed from the test game list, generates a test game start request including the test game ID of the selected test game and the user ID indicating the user, and supplies the test game start request to the communication unit 91.

Here, for example, a test game determined for a genre or a scene of a game the user intends to play from now is selected from among the games distributed by the cloud gaming server 11. In addition, for example, in a case where the level of the user as a player can be specified by an input operation of the user or a setting by the user in advance, information indicating the level of the user may also be stored in the test game start request.

In step S52, the communication unit 91 transmits the test game start request supplied from the quality test processing unit 94 to the test game distribution server 12.

When the test game start request is transmitted, the ideal reference and the response pattern are transmitted from the test game distribution server 12 in response to the test game start request. That is, the test game distribution server 12 executes the processing of step S13 in FIG. 10.

In step S53, the communication unit 91 receives the ideal reference and the response pattern transmitted from the test game distribution server 12 and supplies the ideal reference and the response pattern to the quality test processing unit 94.

The quality test processing unit 94 supplies the ideal reference and the response pattern supplied from the communication unit 91 to a memory (not illustrated) to be recorded. The quality test processing unit 94, as appropriate, generates an acknowledgement (ACK) indicating that sharing of the ideal reference and the response pattern has been completed and transmits the acknowledgement to the test game distribution server 12 via the communication unit 91.

Then, the test game distribution server 12 executes the processing of step S14 in FIG. 10, and the streaming data of the test game is transmitted.

In step S54, the communication unit 91 receives the streaming data transmitted from the test game distribution server 12 and supplies the streaming data to the streaming processing unit 93.

The streaming processing unit 93 executes necessary processing such as decoding on the streaming data of the test game supplied from the communication unit 91 and supplies the media data acquired as a result of the processing to the quality test processing unit 94.

The quality test processing unit 94 temporarily records the media data acquired by the streaming processing unit 93 as data constituting a received data string. The media data of one frame recorded in this manner, particularly, the video data of one frame (video frame) corresponds to the video frame Yₜ of the above-described Equation (1).

In step S55, the quality test processing unit 94 determines whether the media data acquired in step S54 is data of a trigger frame. That is, it is determined whether or not media data of a frame (trigger frame) assigned with meta information has been received.

For example, in a case where meta information has been added to the video data of the frame to be processed supplied as media data from the streaming processing unit 93, the quality test processing unit 94 determines that the frame to be processed is a trigger frame.

When it is determined in step S55 that the data is not of a trigger frame, that is, when it is determined that the data is of a non-trigger frame, the processing of step S56 is not executed, and then the processing proceeds to step S57.

On the other hand, when it is determined in step S55 that the data is of a trigger frame, in step S56, the communication unit 91 transmits a controller signal.

Specifically, for example, the quality test processing unit 94 identifies a response point by referring to meta information added to the video data (video frame) as the media data.

The quality test processing unit 94 refers to the test game ID of the test game being executed and the response pattern determined for the level of the user as a player, and specifies the operation content and the transmission timing determined for the response point.

The quality test processing unit 94 instructs the game input processing unit 95 to generate a controller signal in accordance with the specified operation content and transmission timing.

The game input processing unit 95 generates a controller signal of the designated operation content in accordance with the instruction of the quality test processing unit 94 and supplies the controller signal to the communication unit 91 at the designated transmission timing. In other words, the game input processing unit 95 generates a controller signal based on the meta information and the response pattern in accordance with an instruction from the quality test processing unit 94. At this time, the controller signal is subjected to processing such as encoding as appropriate.

The communication unit 91 transmits the controller signal supplied from the game input processing unit 95 to the test game distribution server 12. In the case where the controller signal is transmitted in this manner, if no transmission loss occurs, the test game distribution server 12 determines that a controller signal has been transmitted in step S15 of FIG. 10.

When the test game is executed (played), the media (video and audio) of the test game are not reproduced by the media reproduction unit 92, that is, the video is not displayed and the audio is not output, and the controller signal is generated without operation input of the user. In other words, the test game is executed in the background.

When the processing of step S56 is executed or it is determined in step S55 that the data is not of a trigger frame, the processing of step S57 is executed thereafter.

In step S57, the quality test processing unit 94 determines whether or not to end the test game.

For example, when the media data of the end frame is supplied from the streaming processing unit 93 and the media data is temporarily recorded as data constituting the received data string, the quality test processing unit 94 determines to end the test game.

In step S57, when it is determined to not end the test game yet, the processing returns to step S54, and the above-described processing is repeated.

On the other hand, in step S57, when it is determined to end the test game, the processing of step S58 is executed thereafter.

In step S58, the quality test processing unit 94 compares the temporarily recorded data string (received data string) of the media data with the ideal reference recorded in the memory (not illustrated) and generates the evaluation data for the quality of user experience. In other words, the experience quality is evaluated.

For example, the quality test processing unit 94 reads the test game ID of the executed test game and the ideal reference determined for the level of the user as a player. Then, the quality test processing unit 94 calculates the error function loss by calculating, for example, the above-described Equation (1) based on the read ideal reference and the temporarily recorded data string (received data string) of the media data and calculates the evaluation data from the error function loss.

Further, the quality test processing unit 94 appropriately forms the acquired evaluation data into a format transmittable to the test game distribution server 12 and supplies the evaluation data to the communication unit 91 or forms the evaluation data into data of a format presentable to the user and supplies the evaluation data to a display serving as the media reproduction unit 92. When the evaluation data is supplied from the quality test processing unit 94, the display serving as the media reproduction unit 92 displays the evaluation data and presents the evaluation data to the user. In this case, for example, the evaluation data may be converted into a score or the like and displayed as appropriate. This enables the user to comprehend the environment related to the user's own game play and to take measures such as setting changes for improving the communication environment.

Note that the quality test processing unit 94 may acquire information (quality evaluation metric) related to quality evaluation such as jitter related to user terminal information and media reproduction, the degree of quality deterioration of media data, and the like or may acquire the information by calculation, together with the calculation of the evaluation data.

For example, the jitter related to the media reproduction can be acquired from the reception state of the streaming data of the test game, and the degree of quality deterioration of the media data can be acquired from the received streaming data (media data) of the test game and the ideal reference.

The quality test processing unit 94 may supply not only the evaluation data but also information related to the quality evaluation such as the terminal information acquired in this manner to the communication unit 91.

In addition, for example, in addition to the error function loss, information related to quality evaluation such as terminal information may be used to calculate the evaluation data.

In step S59, the communication unit 91 transmits the evaluation data supplied from the quality test processing unit 94 to the test game distribution server 12, and the test game execution processing is ended.

Note that, in the case where information related to quality evaluation such as terminal information is also supplied from the quality test processing unit 94, the communication unit 91 also transmits the information related to quality evaluation to the test game distribution server 12.

In addition, after the session is established, in a case where a plurality of test games are executed for each genre, each scene, or the like, the processing of step S52 to step S59 described above is executed for each test game. In this case, for example, the processing of receiving the ideal reference and the response pattern in step S52 and step S53 and the processing of transmitting the evaluation data in step S59 may be executed collectively for a plurality of test games, instead of being executed for each test game.

As described above, the gaming terminal 13 receives the streaming data of the test game from the test game distribution server 12 and generates a controller signal for the trigger frame and transmits the controller signal to the test game distribution server 12 as appropriate. The gaming terminal 13 calculates evaluation data based on the received data string of the media data and the ideal reference and transmits the evaluation data to the test game distribution server 12.

This makes it possible to acquire evaluation data obtained in an E2E manner and taking controller input into account, and thus makes it possible to improve the quality of user experience when the user actually plays the game.

The test game distribution processing and the test game execution processing described above are executed prior to the play of the actual game between the cloud gaming server 11 and the gaming terminal 13, that is, prior to the establishment of the game session. Accordingly, the quality of user experience is estimated (evaluated) before the play of the actual game, and the evaluation data as the estimation result is used at the time of the game play. This allows an appropriate quality of user experience to be guaranteed.

Description of Game Distribution Processing In addition, when the evaluation data is supplied to and recorded in the cloud gaming server 11, the cloud gaming server 11 then executes game distribution processing to distribute the game.

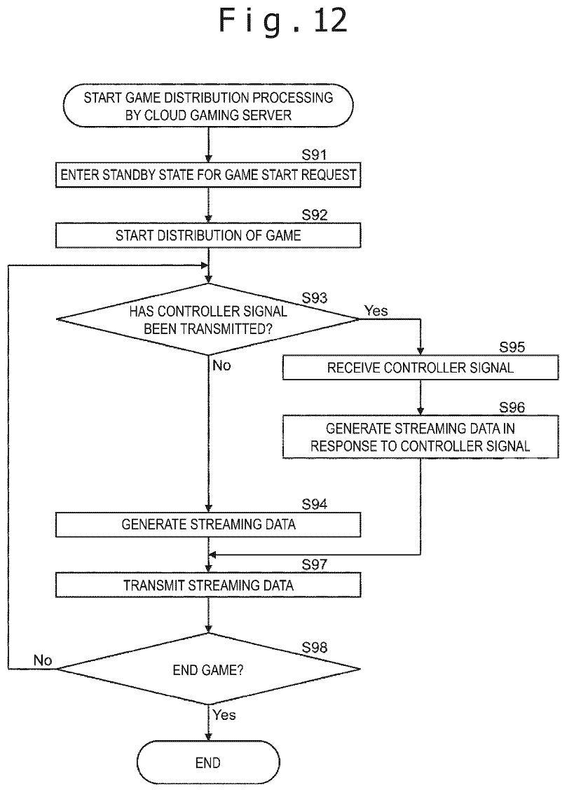

Hereinafter, the game distribution processing by the cloud gaming server 11 will be described with reference to the flowchart of FIG. 12.

In step S91, the media generation unit 41 enters a state of waiting until a game start request is received from the gaming terminal 13, that is, a standby state for a game start request.

In the gaming terminal 13, a game is selected by the user at any timing. Then, a game start request for requesting distribution of the selected game is transmitted from the gaming terminal 13 to the cloud gaming server 11. For example, the game start request includes a user ID and a game ID indicating the game requested to be executed.

When a game start request is transmitted from the gaming terminal 13, the communication unit 45 receives the game start request and supplies the game start request to the media generation unit 41.

In step S92, the media generation unit 41 starts distribution of the game to the gaming terminal 13 in response to the game start request.

Specifically, the media generation unit 41 loads data related to the game indicated by the game start request from a memory (not illustrated) and generates video data and audio data of each frame of the game as media data of the game based on the data.

The streaming processing unit 42 executes necessary processing such as encoding on the media data of the game generated by the media generation unit 41 and supplies the streaming data acquired as a result of the processing to the communication unit 45.

At this time, the streaming processing unit 42 acquires the evaluation data of the user and the like from the user information management unit 43 and performs streaming control.

That is, the user information management unit 43 reads out, from a memory (not illustrated), information indicating the genre and scene of the game intended to be distributed from now and evaluation data recorded in association with the user ID included in the game start request and supplies these to the streaming processing unit 42.

At this time, when information (quality evaluation metric) related to quality evaluation such as terminal information is also recorded in association with the evaluation data, the user information management unit 43 also reads the information related to quality evaluation and supplies the information to the streaming processing unit 42.

The streaming processing unit 42 sets an error correction code, that is, an FEC communication redundancy and a transmission rate on the basis of the evaluation data supplied from the user information management unit 43 and information (quality evaluation metric) related to quality evaluation such as terminal information.

Then, the streaming processing unit 42 generates streaming data based on the media data of the game so that the transmission rate and the FEC of the streaming data correspond to the transmission rate and the FEC of the communication redundancy that have been set and supplies the streaming data to the communication unit 45.

The communication unit 45 transmits the streaming data of the game supplied from the streaming processing unit 42 to the gaming terminal 13. In this manner, streaming distribution of the game is started.

When distribution of the game is started, the media generation unit 41 generates media data of frames of the game at regular intervals. When distribution (play) of the game is started, a controller signal is transmitted from the gaming terminal 13 as a controller input (response) of the user in the game as appropriate.

In step S93, the communication unit 45 determines whether or not a controller signal has been transmitted.

In step S93, if it is determined that no controller signal has been transmitted, in step S94, the media generation unit 41 generates streaming data of a frame to be transmitted in the game.

Specifically, the media generation unit 41 generates media data assuming that there is no controller signal. Also, the streaming processing unit 42 generates streaming data based on the media data generated by the media generation unit 41 while performing streaming control based on the evaluation data and the like described above and supplies the streaming data to the communication unit 45.

On the other hand, in step 593, when it is determined that a controller signal has been transmitted, in step S95, the communication unit 45 receives the controller signal transmitted from the gaming terminal 13 and supplies the controller signal to the game processing unit 44.

The game processing unit 44 executes processing such as decoding as appropriate on the controller signal supplied from the communication unit 45 and supplies the controller signal to the media generation unit 41.

In step S96, the media generation unit 41 generates streaming data in accordance with the controller signal supplied from the game processing unit 44.

Specifically, the media generation unit 41 generates media data reflecting an input operation indicated by the controller signal based on the controller signal. Also, the streaming processing unit 42 generates streaming data based on the media data generated by the media generation unit 41 while performing streaming control based on the evaluation data and the like described above and supplies the streaming data to the communication unit 45.

After the processing of step S94 or step S96 is executed, the processing of step S97 is executed.

In step S97, the communication unit 45 transmits the streaming data of the game supplied from the streaming processing unit 42 to the gaming terminal 13.

In step S98, the media generation unit 41 determines whether or not to end the game.

For example, when the media data of the last frame of the game, that is, the end frame, is generated and the streaming data corresponding to the media data is transmitted, the media generation unit 41 determines to end the game. Specifically, the end frame is generated when the game is played to the end and ended or when end of play is instructed by the user during the play or the like.

In step S98, when it is determined that the game has not yet ended, the processing returns to step S93, and the above-described processing is repeated.

Note that, during the distribution of the game, the user information management unit 43 may transmit the execution request of the test game to the test game distribution server 12 via the communication unit 45 at a timing such as immediately before the play of a predetermined scene of the game.

In such a case, for example, the test game distribution server 12 executes the same processing as the test game distribution processing described with reference to FIG. 10, and the gaming terminal 13 executes the same processing as the test game execution processing described with reference to FIG. 11.

That is, streaming distribution of the test game (play of the test game) and evaluation of the quality of user experience are performed during play of the game.

Then, since the evaluation data and the like acquired by the execution of the test game are transmitted from the test game distribution server 12 to the cloud gaming server 11, the streaming processing unit 42 performs the streaming control of the game based on the evaluation data and the like received by the communication unit 45.

In this manner, by executing the test game even at a timing when no operation is performed by the user during the play of the game, more specifically, during the distribution of the game, it is possible to use, in the streaming control, the evaluation data and the like indicating the evaluation result at a time closer to the current time. As a result, it is possible to perform more appropriate streaming control and further improve the quality of user experience.

On the other hand, in step S98, when it is determined to end the game, the respective units of the cloud gaming server 11 stop the operations being performed, and the game distribution processing is ended.

As described above, the cloud gaming server 11 generates streaming data of the game and transmits the streaming data to the gaming terminal 13 while performing streaming control using evaluation data obtained in an E2E manner and taking controller input into account. This can improve the quality of user experience during game play.

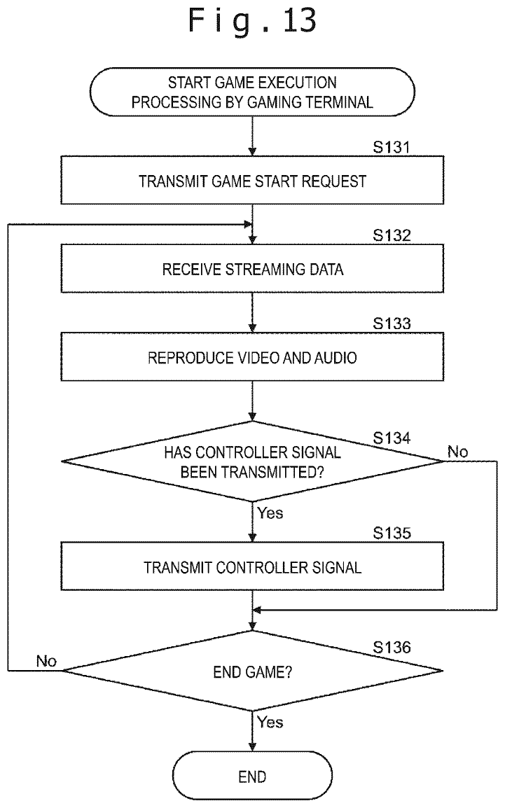

Description of Game Execution Processing When the game distribution processing described with reference to FIG. 12 is executed, the game execution processing illustrated in FIG. 13 is executed in the gaming terminal 13.

Hereinafter, the game execution processing executed by the gaming terminal 13 will be described with reference to the flowchart of FIG. 13. For example, the game execution processing is started when a game is designated by the user and the start of play of the designated game is instructed.

In step S131, the communication unit 91 transmits a game start request to the cloud gaming server 11.

For example, the game input processing unit 95 generates a game start request for requesting execution (start of distribution) of the game designated by the user and supplies the game start request to the communication unit 91. For example, the game start request includes a user ID and a game ID indicating the game requested to be executed.

The communication unit 91 transmits, to the cloud gaming server 11, the game start request supplied from the game input processing unit 95.

When the game start request is transmitted, the cloud gaming server 11 executes the processing of step S92 in FIG. 12 in response to the game start request, and the streaming data of the game is transmitted.

In step S132, the communication unit 91 receives the streaming data transmitted from the cloud gaming server 11 and supplies the streaming data to the streaming processing unit 93.

The streaming processing unit 93 executes necessary processing such as decoding on the streaming data of the game supplied from the communication unit 91 and supplies the media data acquired as a result of the processing to the media reproduction unit 92.

In step S133, the media reproduction unit 92 reproduces the media of the game, that is, the video (video frames) and the audio (audio frames) based on the media data supplied from the streaming processing unit 93.

That is, the media reproduction unit 92 displays the video of the game based on the video data as the media data and outputs the audio of the game based on the audio data as the media data. Then, the user performs controller input (controller operation), that is, an input operation by appropriately operating a button or the like (not illustrated) while viewing the reproduced video or listening to the audio. The result of the input operation performed by the user as appropriate is supplied to the game input processing unit 95.

In step S134, the game input processing unit 95 determines whether or not to transmit a controller signal.

For example, in step S134, when the user performs a controller input and the result of the controller input (the result of the input operation) is supplied to the game input processing unit 95, it is determined to transmit a controller signal.

In step S134, when it is determined to transmit a controller signal, in step S135, the communication unit 91 transmits the controller signal.

That is, the game input processing unit 95 generates a controller signal indicating the operation content of the controller input based on the result of the controller input of the user and supplies the controller signal to the communication unit 91. Then, the communication unit 91 transmits the controller signal supplied from the game input processing unit 95 to the cloud gaming server 11.

On the other hand, in step S134, when it is determined to not transmit a controller signal, the processing of step S135 is not executed, and thereafter, the processing proceeds to step S136.

When the processing of step S135 is executed or it is determined to not transmit a controller signal in step S134, the processing of step S136 is executed thereafter.

In step S136, the streaming processing unit 93 determines whether or not to end the game. For example, the streaming processing unit 93 determines to end the game when the media (video and audio) is reproduced based on the media data of the end frame of the game.

In step S136, when it is determined that the game has not yet ended, the processing returns to step S132, and the above-described processing is repeated.

On the other hand, in step S136, when it is determined to end the game, the respective units of the gaming terminal 13 stop the processing being executed, and the game execution processing is ended.

As described above, the gaming terminal 13 receives streaming data transmitted (distributed) by the cloud gaming server 11 to reproduce game media and generates a controller signal in accordance with a user input operation and transmits the controller signal to the cloud gaming server 11 as appropriate.

In this case, the cloud gaming server 11 performs streaming control based on the evaluation data obtained in an E2E manner and taking controller input into account, and thus on the gaming terminal 13 side, the quality of user experience when the user actually plays the game can be improved.

In the cloud gaming system described above, when a cloud-based game distributed by the cloud gaming server 11 is played, the quality of user experience can be evaluated using at least a single index, that is, evaluation data.

In general, in cloud gaming, there are a wide variety of factors that affect the quality of user experience, and it has been difficult to evaluate the quality of user experience with a single index.

In contrast, in the cloud gaming system of the present technology, by using evaluation data obtained in an E2E manner and taking controller input into account, it is possible to perform quality control, that is, streaming control, in accordance with a combination of one or more of the level of the user (player), the genre of the game, and the scene of the game.

In other words, the streaming processing unit 42 of the cloud gaming server 11 can set the transmission rate and the FEC communication redundancy by estimating the necessary conditions for the user to comfortably play a specific game or the like, for example.

As a result, it is possible to realize more appropriate streaming control and improve the quality of user experience.

### Configuration Example of Computer

The above-described series of processing operations can be executed by hardware or software. In a case in which the series of processing operations is executed by software, a program constituting the software is installed on a computer. Herein, a computer includes a computer incorporated in dedicated hardware, a general-purpose personal computer, for example, that can execute various functions by the installation of various programs, and the like.

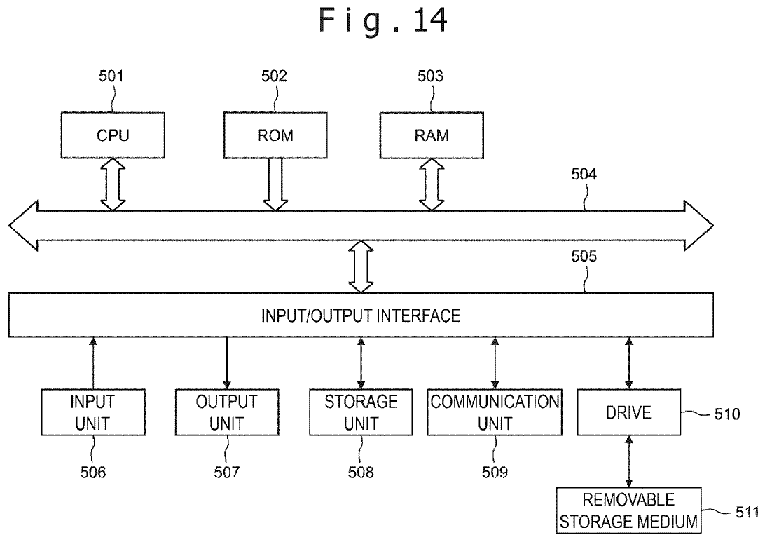

FIG. 14 is a block diagram illustrating a configuration example of hardware of a computer that executes the above-described series of processing operations by a program.

In the computer, a central processing unit (CPU) 501, a read only memory (ROM) 502, and a random access memory (RAM) 503 are connected to each other via a bus 504.

An input/output interface 505 is also connected to the bus 504. The input/output interface 505 is connected to an input unit 506, an output unit 507, a storage unit 508, a communication unit 509, and a drive 510.

The input unit 506 includes a keyboard, a mouse, a microphone, an image sensor, and the like. The output unit 507 includes a display, a speaker, and the like. The storage unit 508 includes a hard disk, a non-volatile memory, and the like. The communication unit 509 includes a network interface and the like. The drive 510 drives a removable storage medium 511 such as a magnetic disk, an optical disk, a magneto-optical disk, or a semiconductor memory.

In the computer configured as described above, the CPU 501, for example, loads a program stored in the storage unit 508 into the RAM 503 via the input/output interface 505 and the bus 504 and executes the program, thereby performing the series of processing operations described above.

The program executed by the computer (CPU 501) can be stored, for example, on the removable storage medium 511 which is a package medium or the like, and provided. Further, the program can be provided via a wired or wireless transmission medium such as a local area network, the Internet, or digital satellite broadcasting.

In the computer, the program can be installed in the storage unit 508 via the input/output interface 505 by inserting the removable storage medium 511 into the drive 510. The program can be received by the communication unit 509 via a wired or wireless transmission medium and installed in the storage unit 508. In addition, the program can be installed in advance in the ROM 502 or the storage unit 508.

Note that the program executed by the computer may be a program in which processing is performed in time series in the order described in the present specification, or may be a program in which processing is performed in parallel or at a necessary timing such as when a call is performed.

Also, the embodiments of the present technology are not limited to the above-described embodiments, and various modifications can be made without departing from the gist of the present technology.

For example, the present technology can have a configuration of cloud computing in which one function is shared and processed in cooperation by a plurality of devices via a network.

Also, each step described in the above-described flowchart can be performed by one device or can be shared and executed by a plurality of devices.

Further, when a single step includes multiple processing operations, the multiple processing operations included in that single step can be executed by a single device, or can be shared and executed by multiple devices.

Further, the present technology may have the following configurations.

(1)

An information processing device including:
a media generation unit configured to generate media data for reproducing media including at least one of video and audio of a respective one of a plurality of frames of a test game for evaluating quality of user experience, the plurality of frames including a frame assigned with meta information for inducing transmission of a controller signal; and
a communication unit configured to transmit the media data to a gaming terminal, wherein
in a case where the controller signal transmitted by the gaming terminal is received by the communication unit, the media generation unit generates the media data reflecting an operation indicated by the controller signal.
   (2)

The information processing device according to (1), wherein
prior to play of a game executed on the gaming terminal or during play of the game, the communication unit performs streaming distribution of the media data of the test game corresponding to the game to the gaming terminal.
   (3)

The information processing device according to (2), wherein
the test game is prepared for a respective one of a plurality of items related to the game.
   (4)

The information processing device according to (3), wherein
the items include at least one of a genre and a scene of the game.
   (5)

The information processing device according to any one of (2) to (4), wherein
the communication unit transmits, to the gaming terminal, an ideal reference that is the media data of the media reproduced in a case where the test game is played in an ideal environment.
   (6)

The information processing device according to (5), wherein
the communication unit transmits, to the gaming terminal, a response pattern that is used in generation of the controller signal at the gaming terminal and indicates a pattern of a response when a frame assigned with the meta information is received.
   (7)

The information processing device according to (6), wherein
the ideal reference or the response pattern is prepared for respective levels of the user or respective types of characters operated in the game.
   (8)

The information processing device according to any one of (5) to (7), wherein
the communication unit receives, from the gaming terminal, evaluation data indicating an evaluation result of the quality of user experience, the evaluation data being generated based on the media data of the test game received by the gaming terminal and the ideal reference.
   (9)

The information processing device according to (8), further including:
a streaming processing unit configured to perform streaming control, based on the evaluation data, during streaming distribution of media data of the game to the gaming terminal.
   (10)

The information processing device according to (9), wherein
the streaming processing unit performs control of a transmission rate or a communication redundancy as the streaming control.
   (11)

An information processing method including:
generating, by an information processing device, media data for reproducing media including at least one of video and audio of a respective one of a plurality of frames of a test game for evaluating quality of user experience, the plurality of frames including a frame assigned with meta information for inducing transmission of a controller signal;
transmitting, by the information processing device, the media data to a gaming terminal; and
in a case where the controller signal transmitted by the gaming terminal is received, generating, by the information processing device, the media data reflecting an operation indicated by the controller signal.
   (12)

An information processing device including:
a communication unit configured to receive, from a server, media data for reproducing media including at least one of video and audio of a respective one of a plurality of frames of a test game for evaluating quality of user experience, the plurality of frames including a frame assigned with meta information for inducing transmission of a controller signal; and
a quality test processing unit configured to generate evaluation data indicating an evaluation result of the quality of user experience, based on an ideal reference that is the media data of the media reproduced in a case where the test game is played in an ideal environment, and the media data received from the server, wherein
in a case where the media data of a frame assigned with the meta information is received, the communication unit transmits the controller signal to the server.
   (13)

The information processing device according to (12), wherein
prior to play of a game executed on the information processing device or during play of the game, the communication unit receives the media data of the test game corresponding to the game via streaming distribution by the server.
   (14)

The information processing device according to (13), wherein
the test game is prepared for a respective one of a plurality of items related to the game.
   (15)

The information processing device according to (14), wherein
the items include at least one of a genre and a scene of the game.
   (16)

The information processing device according to any one of (13) to (15), further including:
a game input processing unit configured to generate the controller signal based on the meta information and a response pattern indicating a pattern of a response when a frame assigned with the meta information is received.
   (17)

The information processing device according to (16), wherein
the ideal reference or the response pattern is prepared for respective levels of the user or respective types of characters operated in the game.
   (18)

The information processing device according to (16) or (17), wherein
the communication unit receives the ideal reference and the response pattern from the server.
   (19)

The information processing device according to any one of (12) to (18), wherein
the quality test processing unit generates the evaluation data by calculating an error function based on the ideal reference and the media data received from the server.
   (20)

An information processing method including:
receiving, by an information processing device, from a server, media data for reproducing media including at least one of video and audio of a respective one of a plurality of frames of a test game for evaluating quality of user experience, the plurality of frames including a frame assigned with meta information for inducing transmission of a controller signal;
generating, by the information processing device, evaluation data indicating an evaluation result of the quality of user experience, based on an ideal reference that is the media data of the media reproduced in a case where the test game is played in an ideal environment, and the media data received from the server; and
in a case where the media data of a frame assigned with the meta information is received, transmitting, by the information processing device, the controller signal to the server.
   (21)

An information processing system including:
a server; and
a gaming terminal, wherein
the server includes
a media generation unit configured to generate media data for reproducing media including at least one of video and audio of a respective one of a plurality of frames of a test game for evaluating quality of user experience, the plurality of frames including a frame assigned with meta information for inducing
transmission of a controller signal, and a first communication unit configured to transmit the media data to the gaming terminal,
the gaming terminal includes
a second communication unit configured to receive the media data transmitted by the first communication unit of the server, and
a quality test processing unit configured to generate evaluation data indicating an evaluation result of the quality of user experience, based on an ideal reference that is the media data of the media reproduced in a case where the test game is played in an ideal environment, and the media data received from the server,
in a case where the media data of the frame assigned with the meta information is received, the second communication unit of the gaming terminal transmits the controller signal to the server, and
in a case where the controller signal transmitted by the second communication unit of the gaming terminal is received by the first communication unit, the media generation unit of the server generates the media data reflecting an operation indicated by the controller signal.

### REFERENCE SIGNS LIST

11 Cloud gaming server, 12 Test game distribution server, 13 Gaming terminal, 71 Media generation unit, 72 Streaming processing unit, 73 Test game management unit, 74 Game processing unit, 75 Communication unit, 76 User information management unit, 91 Communication unit, 92 Media reproduction unit, 93 Streaming processing unit, 94 Quality test processing unit, 95 Game input processing unit

1. An information processing device comprising:
a media generation unit configured to generate media data for reproducing media including at least one of video and audio of a respective one of a plurality of frames of a test game for evaluating quality of user experience, the plurality of frames including a frame assigned with meta information for inducing transmission of a controller signal; and
a communication unit configured to transmit the media data to a gaming terminal, wherein
in a case where the controller signal transmitted by the gaming terminal is received by the communication unit, the media generation unit generates the media data reflecting an operation indicated by the controller signal.

2. The information processing device according to claim 1, wherein
prior to play of a game executed on the gaming terminal or during play of the game, the communication unit performs streaming distribution of the media data of the test game corresponding to the game to the gaming terminal.

3. The information processing device according to claim 2, wherein
the test game is prepared for a respective one of a plurality of items related to the game.

4. The information processing device according to claim 3, wherein
the items include at least one of a genre and a scene of the game.

5. The information processing device according to claim 2, wherein
the communication unit transmits, to the gaming terminal, an ideal reference that is the media data of the media reproduced in a case where the test game is played in an ideal environment.

6. The information processing device according to claim 5, wherein
the communication unit transmits, to the gaming terminal, a response pattern that is used in generation of the controller signal at the gaming terminal and indicates a pattern of a response when a frame assigned with the meta information is received.

7. The information processing device according to claim 6, wherein
the ideal reference or the response pattern is prepared for respective levels of the user or respective types of characters operated in the game.

8. The information processing device according to claim 5, wherein
the communication unit receives, from the gaming terminal, evaluation data indicating an evaluation result of the quality of user experience, the evaluation data being generated based on the media data of the test game received by the gaming terminal and the ideal reference.

9. The information processing device according to claim 8, further comprising:
a streaming processing unit configured to perform streaming control, based on the evaluation data, during streaming distribution of media data of the game to the gaming terminal.

10. The information processing device according to claim 9, wherein
the streaming processing unit performs control of a transmission rate or a communication redundancy as the streaming control.

11. An information processing method comprising:
generating, by an information processing device, media data for reproducing media including at least one of video and audio of a respective one of a plurality of frames of a test game for evaluating quality of user experience, the plurality of frames including a frame assigned with meta information for inducing transmission of a controller signal;
transmitting, by the information processing device, the media data to a gaming terminal; and
in a case where the controller signal transmitted by the gaming terminal is received, generating, by the information processing device, the media data reflecting an operation indicated by the controller signal.

12. An information processing device comprising:
a communication unit configured to receive, from a server, media data for reproducing media including at least one of video and audio of a respective one of a plurality of frames of a test game for evaluating quality of user experience, the plurality of frames including a frame assigned with meta information for inducing transmission of a controller signal; and
a quality test processing unit configured to generate evaluation data indicating an evaluation result of the quality of user experience, based on an ideal reference that is the media data of the media reproduced in a case where the test game is played in an ideal environment, and the media data received from the server, wherein
in a case where the media data of a frame assigned with the meta information is received, the communication unit transmits the controller signal to the server.

13. The information processing device according to claim 12, wherein
prior to play of a game executed on the information processing device or during play of the game, the communication unit receives the media data of the test game corresponding to the game via streaming distribution by the server.

14. The information processing device according to claim 13, wherein
the test game is prepared for a respective one of a plurality of items related to the game.

15. The information processing device according to claim 14, wherein
the items include at least one of a genre and a scene of the game.

16. The information processing device according to claim 13, further comprising:
a game input processing unit configured to generate the controller signal based on the meta information and a response pattern indicating a pattern of a response when a frame assigned with the meta information is received.

17. The information processing device according to claim 16, wherein
the ideal reference or the response pattern is prepared for respective levels of the user or respective types of characters operated in the game.

18. The information processing device according to claim 16, wherein
the communication unit receives the ideal reference and the response pattern from the server.

19. The information processing device according to claim 12, wherein
the quality test processing unit generates the evaluation data by calculating an error function based on the ideal reference and the media data received from the server.

20. An information processing method comprising:
receiving, by an information processing device, from a server, media data for reproducing media including at least one of video and audio of a respective one of a plurality of frames of a test game for evaluating quality of user experience, the plurality of frames including a frame assigned with meta information for inducing transmission of a controller signal;
generating, by the information processing device, evaluation data indicating an evaluation result of the quality of user experience, based on an ideal reference that is the media data of the media reproduced in a case where the test game is played in an ideal environment, and the media data received from the server; and
in a case where the media data of a frame assigned with the meta information is received, transmitting, by the information processing device, the controller signal to the server.
